(19) United States
(12) Patent Application Publication
(10) Pub. No.: US 2008/0148198 A1
(43) Pub. Date: Jun. 19, 2008

(54) HOTSPOT TOTALIZATION METHOD, PATTERN CORRECTION METHOD, AND PROGRAM

(76) Inventor: Suigen KYOH, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/951,868

(22) Filed: Dec. 6, 2007

(30) Foreign Application Priority Data
Dec. 8, 2006 (JP) 2006-332149

(51) Int. Cl. G06F 17/50

(52) U.S. Cl. 716/4; 716/19

(57) ABSTRACT

A hotspot totalization method includes the following arrangement. Data related to a mask pattern is generated on the basis of data related to a test pattern formed by laying out a plurality of kinds of basic cells at a plurality of locations. A predicted pattern to be formed on a substrate by using the mask pattern is acquired by performing process simulation for the data related to the mask pattern. The process simulation is performed to acquire a plurality of predicted patterns based on a plurality of process parameters. It is determined whether a first hotspot exists in each of the predicted patterns. A second hotspot on the test pattern corresponding to the first hotspot is specified if it is determined that the first hotspot exists on the predicted pattern. For each of the plurality of kinds of basic cells, the number of locations including the second hotspots is totalized.

### CROSS-REFERENCE TO RELATED APPLICATIONS

This application is based upon and claims the benefit of priority from prior Japanese Patent Application No. 2006-332149, filed Dec. 8, 2006, the entire contents of which are incorporated herein by reference.

### BACKGROUND OF THE INVENTION

1. Field of the Invention

The present invention relates to a hotspot totalization method of totalizing basic cells including hotspots, a pattern correction method of correcting basic cells including hotspots, and a program.

2. Description of the Related Art

As the micropatterning technology for semiconductor elements progresses, it is becoming difficult to form a pattern conforming to a designed circuit on a semiconductor substrate. One of the reasons is that the resolution of an exposure apparatus cannot improve to keep pace with advances in micropatterning technologies for semiconductor elements, and the transfer quality of a pattern in the lithography process degrades. The transfer quality of a pattern also becomes poor when process parameters such as an exposure dose and a focus amount slightly vary due to use of such an exposure apparatus with an insufficient resolution.

A pattern with a poor transfer quality greatly influences the manufacturing yield. To prevent this, such a pattern is prohibited by design restrictions (design rules). If the design restrictions are too strict, the number of possible variations of patterns decrease. The size of a semiconductor device cannot always be reduced by micropatterning the semiconductor elements. Hence, the design restrictions cannot be so strict. As a result, a pattern with a hotspot (quality degradation pattern) may be mixed in the designed circuit pattern, even if it is formed according to the design restrictions.

To prevent such mixture of a pattern with a hotspot, it is necessary to specify a pattern with a hotspot and correct the specified pattern with a hotspot. Specification and correction of a pattern with a hotspot are executed for each small-scale cell such as a standard cell or a basic cell (e.g., leaf cell) of a memory macro (S. Kyoh et al, “Lithography oriented DfM for 65 nm and beyond”, Proc. SPIE Vol. 6156 (2006)).

Conventionally, a pattern with a hotspot is specified and corrected in the following way.

One of a plurality of small-scale cells that are prepared in advanced is selected. Process simulations such as lithography simulation are performed for the selected small-scale cell, thereby predicting a pattern to be formed on a substrate. Whether the predicted pattern includes a hotspot is determined. If it is determined that the pattern includes no hotspot, the small-scale cell is registered in a cell library. On the other hand, if it is determined that the pattern includes a hotspot, the small-scale cell is subjected to pattern correction to ensure a predetermined process margin. The same determination and process (registration or pattern correction) are done for the remaining small-scale cells.

However, it is becoming difficult to specify and correct a pattern with a hotspot by using the conventional method described above because the distance between patterns that influence each other in the manufacturing process almost equals the feature size of the pattern now.

### BRIEF SUMMARY OF THE INVENTION

According to a first aspect of the present invention, there is provided a hotspot totalization method comprising: generating data related to a mask pattern on the basis of data related to a test pattern formed by laying out a plurality of kinds of basic cells Ci (i=1, 2, . . . ) at a plurality of locations Sij (j=1, 2, . . . ); acquiring a predicted pattern to be formed on a substrate by using the mask pattern by performing process simulation for the data related to the mask pattern, the process simulation being performed to acquire a plurality of predicted patterns based on a plurality of process parameters; determining whether a first hotspot exists in each of the plurality of predicted patterns; specifying a second hotspot on the test pattern corresponding to the first hotspot if it is determined that the first hotspot exists on the predicted pattern; and totalizing, for each of the plurality of kinds of basic cells Ci, the number of locations Sij including the second hotspots.

According to a second aspect of the present invention, there is also provide a pattern correction method comprising: generating data related to a mask pattern on the basis of data related to a test pattern formed by laying out a plurality of kinds of basic cells Ci (i=1, 2, . . . ) at a plurality of locations Sij (j=1, 2, . . . ); acquiring a predicted pattern to be formed on a substrate by using the mask pattern by performing process simulation for the data related to the mask pattern, the process simulation being performed to acquire a plurality of predicted patterns based on a plurality of process parameters; determining whether a first hotspot exists in each of the plurality of predicted patterns; specifying a second hotspot on the test pattern corresponding to the first hotspot if it is determined that the first hotspot exists on the predicted pattern; totalizing, for each of the plurality of kinds of basic cells Ci, the number of locations Sij including the second hotspots; selecting, from the plurality of kinds of basic cells Ci, the basic cell Ci including the second hotspot in at least one location Sij; and correcting the test pattern of the basic cell Ci including the second hotspot in at least one location Sij to remove the second hotspot.

According to a third aspect of the present invention, there is also provided a program to be executed by a computer, comprising: generating data related to a mask pattern on the basis of data related to a test pattern formed by laying out a plurality of kinds of basic cells Ci (i=1, 2, . . . ) at a plurality of locations Sij (j=1, 2, . . . ); acquiring a predicted pattern to be formed on a substrate by using the mask pattern by performing process simulation for the data related to the mask pattern, the process simulation being performed to acquire a plurality of predicted patterns based on a plurality of process parameters; determining whether a first hotspot exists in each of the plurality of predicted patterns; specifying a second hotspot on the test pattern corresponding to the first hotspot if it is determined that the first hotspot exists on the predicted pattern; and totalizing, for each of the plurality of kinds of basic cells Ci, the number of locations Sij including the second hotspots.

### BRIEF DESCRIPTION OF THE SEVERAL VIEWS OF THE DRAWING

FIG. 1 is a flowchart illustrating a cell library generation method according to a first embodiment;

FIG. 2 is a view showing an example of a small-scale cell library (standard cell library);

FIGS. 3A and 3B are views schematically showing an example of a test pattern;

FIG. 4 is a view schematically showing the locations of standard cells_001;

FIG. 5 is a view schematically showing the state of standard cell_001 in step S8;

FIG. 6 is a flowchart illustrating a cell library generation method according to the second embodiment;

FIG. 7 is a view schematically showing standard cell_001 laid out at location_001;

FIG. 8 is a flowchart illustrating a cell library generation method according to the third embodiment;

FIG. 9 is a view showing examples of the finish shapes and dimensions of hotspots; and

FIG. 10 is a view showing examples of the finish shapes and dimensions of hotspots A of another type.

### DETAILED DESCRIPTION OF THE INVENTION

As described above, the distance between patterns that influence each other in the manufacturing process almost equals the size of a basic cell. For example, the optical radius as the representative value of the distance between patterns that influence each other in the lithography process almost equals the size (cell size) of a standard cell serving as a basic cell. More specifically, the optical radius and cell size are about 2 μm.

Under these circumstances, a small-scale basic cell as an inspection target is expected to be greatly affected by the peripheral pattern environment. For this reason, a cell may be able to pass muster at the inspection in a pattern environment but not in another environment. The conventional method described in “BACKGROUND OF THE INVENTION” does not consider the influence of peripheral patterns. Hence, a small-scale cell with a hotspot which is specified and corrected by the conventional method can be a small-scale cell with a hotspot depending on the layout of the small-scale cells in the periphery.

The embodiments of the present invention considering the above-described situations will be described below with reference to the accompanying drawing.

### FIRST EMBODIMENT

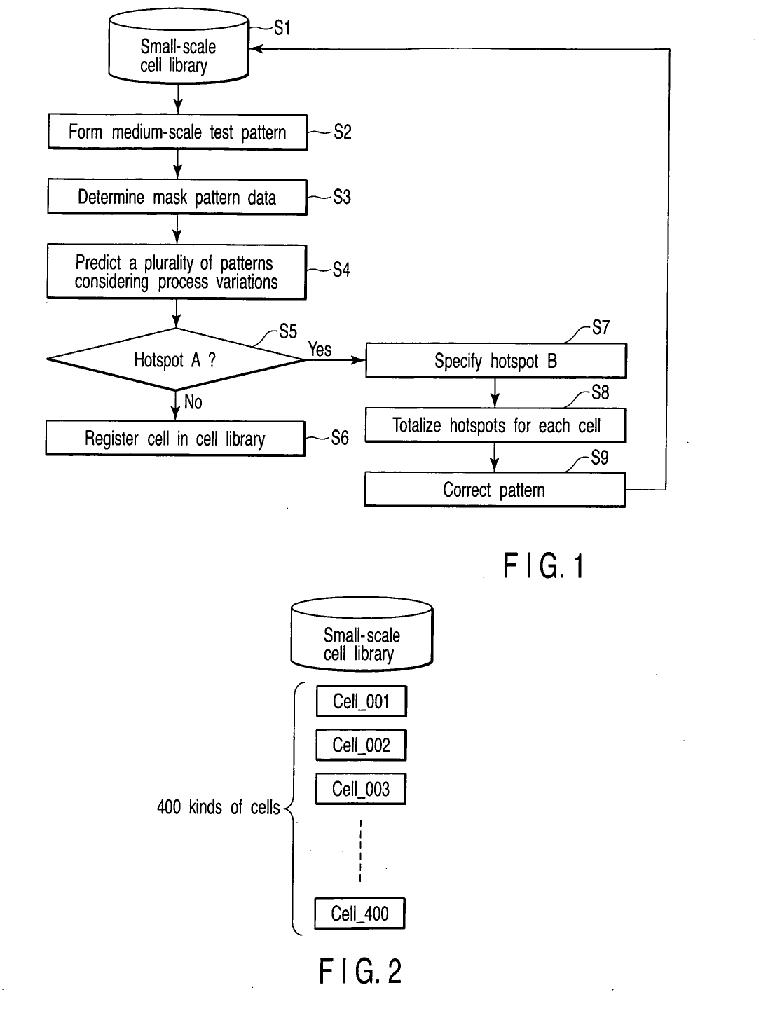

FIG. 1 is a flowchart illustrating a cell library generation method according to the first embodiment.

### [S1]

A library (small-scale cell library) containing a plurality of small-scale cells is prepared. The plurality of small-scale cells are formed on the basis of design restrictions (design rules).

A description will be made here using a small-scale cell library shown in FIG. 2 as an example. This small-scale cell library includes 400 kinds of cells_001 to 400 (a plurality of kinds of basic cells Ci). The small-scale cell library will be explained as a standard cell library hereinafter.

The small-scale cell library is not limited to the standard cell library and may be a library containing, e.g., the basic cells of a memory macro. An example of the basic cell of a memory macro is a leaf cell.

### [S2]

Using the standard cells_001 to 400, a medium-scale test patterns (to be simply referred to as test patterns hereinafter) simulating a random logic design are formed. In a random logic pattern, standard cells are laid out anywhere on the upper, lower, left, and right sides without restrictions. Hence, the standard cells of the respective types are laid out in various environments.

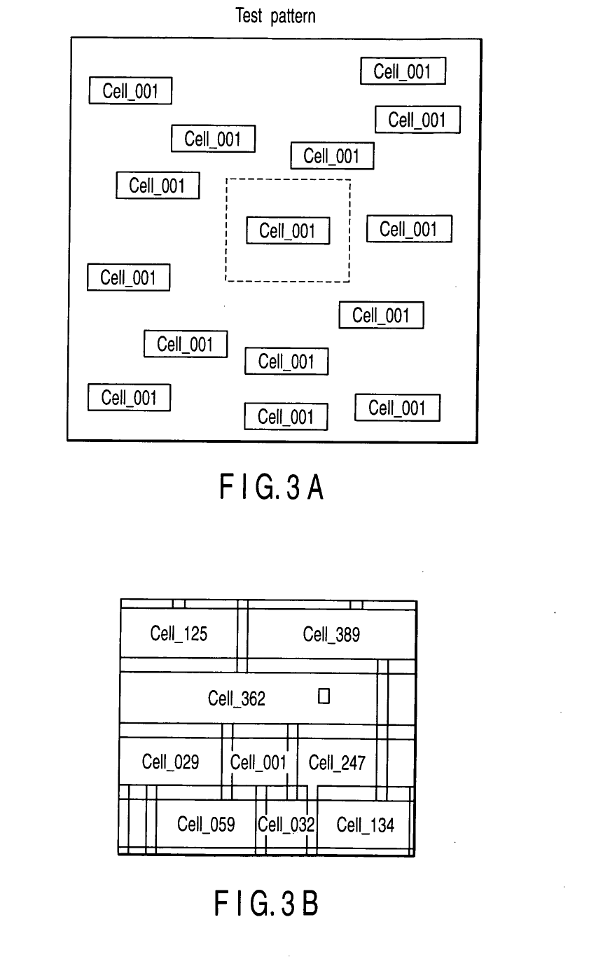

FIGS. 3A and 3B schematically show an example of the test pattern. The standard cells are laid out at about 500 locations. The expression “about 500 locations” is used because the number of locations changes between the standard cells. For example, standard cells_001 are laid out at 500 points, and standard cells_002 are laid out at 501 points. Note that all kinds of standard cells may be laid out at the same number of locations.

FIG. 3A shows only 15 standard cells_001 for the illustrative convenience. Actually, about 500 standard cells_001 exist in the test pattern. This also applies to standard cells_002 to 400.

As shown in FIG. 3B, a plurality of standard cells are laid out around each standard cell. FIG. 3B shows the neighborhood of standard cell_001 at the central portion indicated by the broken line in FIG. 3A. Such a standard cell is wholly surrounded by other standard cells (laid out on the upper, lower, left, and right sides).

### [S3]

Optical proximity correction is executed for the data of the test pattern, thereby determining the data of a photomask pattern (to be referred to as mask pattern data hereinafter).

### [S4]

Process simulations (lithography simulation and working simulation) are performed for the mask pattern data, thereby predicting a pattern to be formed on a substrate.

In this embodiment, to specify a spot (first hotspot) with a small margin relative to the process variation on the predicted pattern, the process simulations (lithography simulation and working simulation) are performed in consideration of the process variation.

More specifically, to specify a spot (first hotspot) with a small margin relative to the variation in the lithography process on the predicted pattern, the lithography simulation is performed under a plurality of (M) conditions based on varying process parameters.

Examples of process parameters in the lithography process are an exposure dose and a focus amount. The plurality of (M) conditions may include a condition without any variation (each process parameter has a predetermined value).

Similarly, to specify a spot (first hotspot) with a small margin relative to the variation in the working process on the predicted pattern, the working simulation is performed under a plurality of (N) conditions based on varying process conditions (e.g., parameters).

Examples of process parameters in the working process are the energy of an etchant, working time (etching time), and a variation in in-plane dimensions. The plurality of (N) conditions may include a condition without any variation (each process parameter has a predetermined value).

The number of predicted patterns acquired by the process simulations is M×N. The numbers M and N of variations of process parameters are preferably as large as possible. The predicted pattern may be acquired by considering the variations in only one of the lithography process and working process.

### [S5]

For each of the M×N predicted patterns, it is determined by a known method whether a hotspot A (first hotspot A) is present.

### [S6]

If it is determined that none of the M×N predicted patterns includes any hotspot A, standard cell_S (S=001 to 400) is registered in the standard cell library as a cell to be used actually (end of cell library generation).

### [S7]

On the other hand, if it is determined in step S5 that a hotspot A is present, a hotspot B (second hotspot) in the test pattern corresponding to the hotspot A is specified by a known method. The position of the specified hotspot B is defined by the location of the standard cell to which the hotspot B belongs.

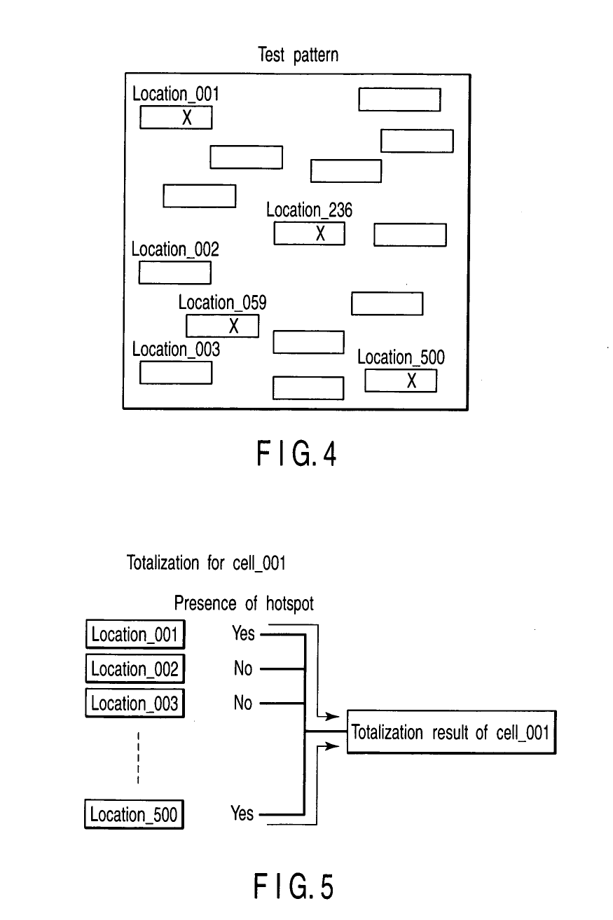

FIG. 4 is a view schematically showing the locations of standard cells_001. The locations are expressed by location_001, location_002, . . . location_500. Each location is represented by using, e.g., the position coordinates of at least one of the four corners of standard cell_001. Each standard cell_001 to which the hotspot B belongs has a symbol x.

FIG. 4 shows only 15 locations. Actually, there are about 500 locations. Standard cells_002 to 400 (not shown) are also laid out at about 500 locations.

### [S8]

On the basis of the process result in step S7, For each standard cell, locations having the hotspots B are totalized. FIG. 5 schematically shows the state of standard cell_001 in step S8.

As a result of totalization of the locations with hotspots B, a standard cell including a hotspot B in at least one location can be determined as a dangerous cell (dangerous cell candidate) which could generate a hotspot A on the substrate. The dangerous cell candidate may influence the manufacturing yield of semiconductor devices.

According to the method of totalizing locations with the hotspots B of this embodiment (hotspot totalization method; steps S1 to S8), it is possible to easily (efficiently and reliably) determine on the basis of the result (hotspot totalization result) of totalizing the locations with hotspots B whether the prepared standard cell library (step S1) includes a dangerous cell candidate.

### [S9]

For a standard cell including a hotspot B in at least one location, i.e., each standard cell determined as a dangerous cell candidate, the pattern of the standard cell is corrected (pattern correction) to remove the hotspots B from all locations. This prevents generation of a hotspot A on the substrate (wafer).

As described above, according to the pattern correction method (step S9) of this embodiment, a dangerous cell candidate can easily be specified by using the hotspot totalization result. It is therefore possible to easily (efficiently and reliably) execute pattern correction to prevent generation of a hotspot A.

After that, the standard cell determined as a dangerous cell candidate in the small-scale cell library in step S1 is replaced with a standard cell that has undergone pattern correction, thereby updating the small-scale cell library. Steps S2 to S5 are executed again by using the updated small-scale cell library (updated cell library). In step S5, it is confirmed whether NO is obtained. That is, the updated cell library is verified.

If YES in step S5, steps S7 to S9 and S1 to S5 are repeated until NO is obtained in step S5 (recorrection process). With this process, a small-scale cell library (designed pattern) robust against process variations can be obtained, and semiconductor devices can be manufactured at a high yield.

If NO is not obtained in step S5 even after the recorrection process is executed a predetermined number of times or more, the recorrection process may be interrupted.

### SECOND EMBODIMENT

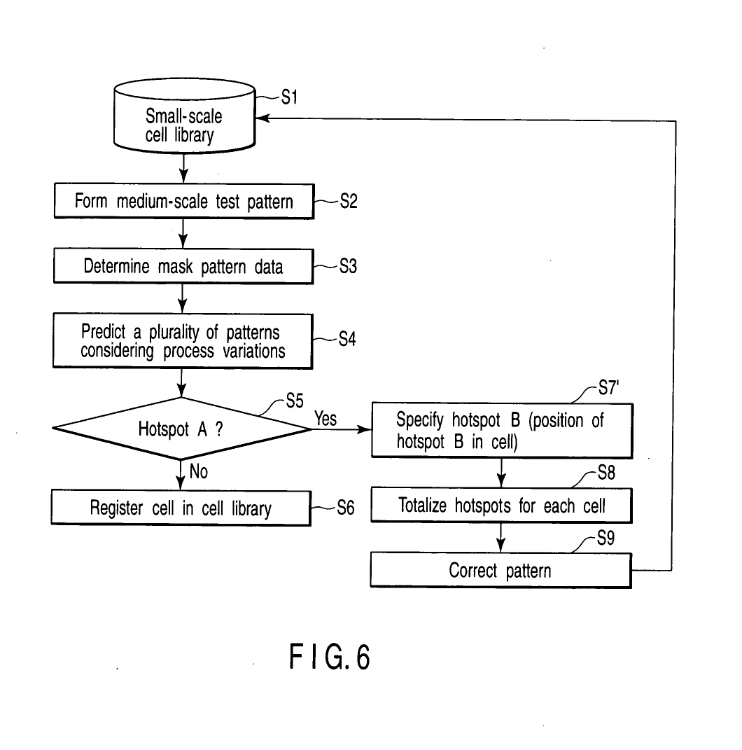

FIG. 6 is a flowchart illustrating a cell library generation method according to the second embodiment. The same step numbers as in FIG. 1 denote the same processes in FIG. 6, and a detailed description thereof will not be repeated.

In the first embodiment, the position of the hotspot B is specified by the location of the standard cell including to which the hotspot B belongs (step S7). In the second embodiment, the position of a hotspot B is specified by its position in the standard cell to which the hotspot B belongs (step S7′).

Even in this embodiment, the same effect as in the first embodiment is obtained. Additionally, according to this embodiment, since the position of the hotspot B (spot to be corrected) in a standard cell can be known, pattern correction can be done more easily (efficiently and reliably).

The location of a standard cell including the hotspot B and the position of the hotspot B can be specified by a known method. It is therefore possible to easily specify the position of the hotspot B in the standard cell. This will be described in detail by exemplifying standard cell_001 laid out at location_001.

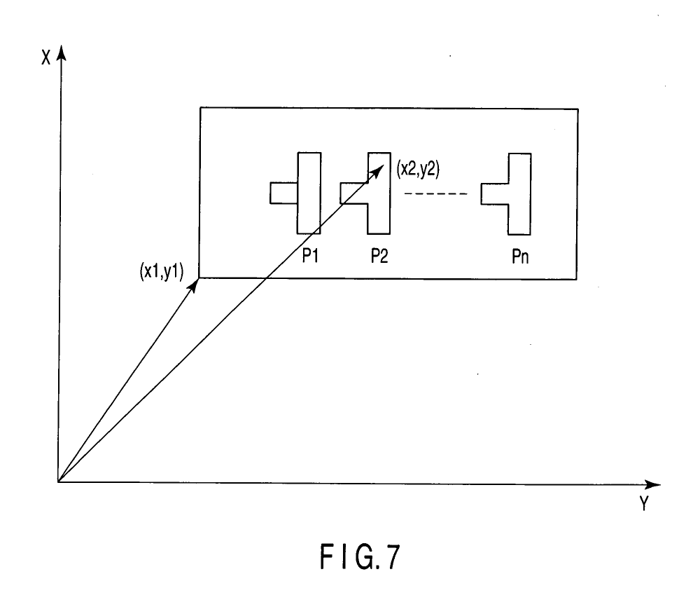

FIG. 7 schematically shows standard cell_001 laid out at location_001 in a test pattern. Standard cell_001 includes a plurality of patterns P1, P2, . . . , Pn.

Referring to FIG. 7, the position of standard cell_001 laid out at location_001 is represented by (x1,y1) using an X-Y orthogonal coordinate system having its origin at the lower left of the test pattern. The position of the hotspot in standard cell_001 is represented by (x2,y2) using the X-Y coordinate system.

Hence, the position of the hotspot in standard cell_001 is represented by (x2-x1,y2-y1) using the above coordinate values (x1,y1) and (x2,y2), and an X-Y orthogonal coordinate system (not shown) having its origin at the lower left of the standard cell_001.

If the position (area) of a hotspot in a standard cell is known in advance, as in this embodiment, the presence of the hotspot may be presented to the operator. For example, a graphic pattern may be displayed on a display to notify the operator that a hotspot exists in the test pattern.

### THIRD EMBODIMENT

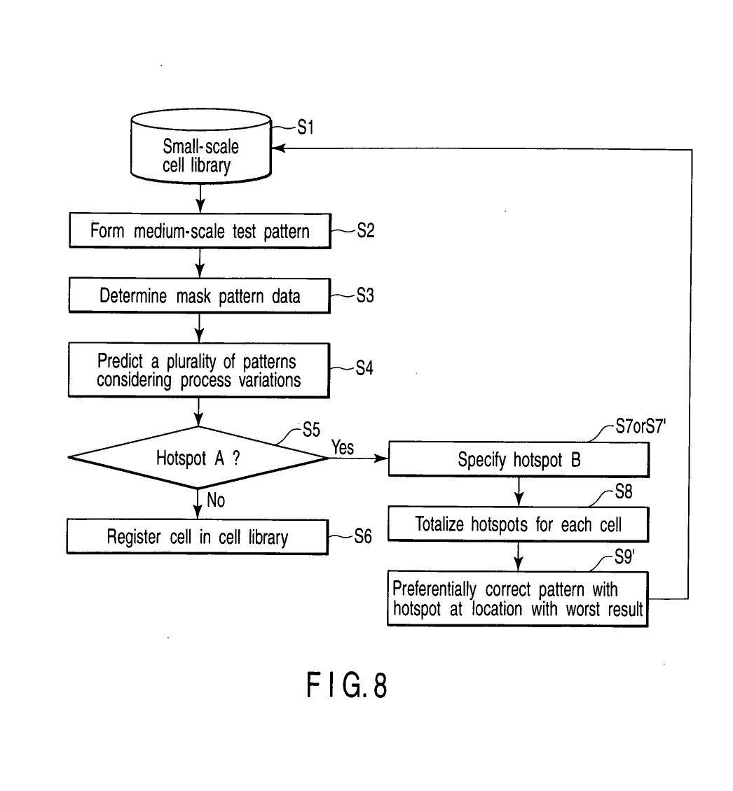

FIG. 8 is a flowchart illustrating a cell library generation method according to the third embodiment. The same step numbers as in FIGS. 1 and 6 denote the same processes in FIG. 8, and a detailed description thereof will not be repeated.

The third embodiment is different from the first and second embodiments in the following point. That is, for standard cells including hotspots B in at least two locations, a standard cell laid out at a location corresponding to the most dangerous hotspot B is preferentially corrected (step S9′).

As an example of preferential correction of a standard cell laid out at a location corresponding to the most dangerous hotspot B, a case wherein only a standard cell laid out at a location corresponding to the most dangerous hotspot B will be described below.

If many locations include hotspots B, and the finish dimension values vary between the locations, the method and amount of pattern correction can hardly be determined. Hence, pattern correction is difficult. According to this embodiment, however, even when many locations include hotspots B, only one location is subjected to correction. Hence, pattern correction can easily be executed.

If pattern correction is done such that the determination result in step S5 becomes NO in association with the most dangerous hotspot B, the determination result in step S5 is expected to be NO even for the remaining hotspots B.

Hence, when pattern correction is done such that the determination result in step S5 becomes NO regarding the most dangerous hotspot B, the area to be verified need only include the most dangerous hotspot B and its peripheral patterns. In this case, the determination in step S5 executed again after step S9′ is done for only the most dangerous hotspot B and its peripheral patterns. It is therefore possible to suppress the area of process simulations for verification and consequently largely suppress the verification cost and time.

The mask pattern (step S3) to be used at the time of verification is formed on the basis of data about the standard cell laid out at a location corresponding to the most dangerous hotspot B and patterns located within a predetermined distance D from the standard cell.

The patterns located within the predetermined distance D are determined by, e.g., the specifications of process simulation (at least one of lithography simulation and working simulation) to be used. This will be described below in detail.

To predict a pattern to be formed on a substrate in correspondence with a standard cell laid out at a location corresponding to the most dangerous hotspot B by process simulation, data about the standard cell and its peripheral patterns is used. The patterns around the standard cell are defined as patterns located within a predetermined distance D′ (e.g., several μm) from the outer periphery of the standard cell. In this case, the predetermined distance D equals the predetermined distance D′.

The predetermined distance D may be determined empirically.

In the above-described example, the target of the determination in step S5 executed again after step S9 includes the most dangerous hotspot B and its peripheral patterns. However, the target may include only the most dangerous hotspot B.

To attach importance to the verification accuracy, the correction target may be expanded to correct, e.g., the standard cell laid out at the most dangerous hotspots B and that laid at the second most dangerous hotspot B.

The method of specifying the most dangerous hotspot B will be described next in detail by exemplifying standard cell_001 of the test pattern shown in FIG. 4. In the case to be described below, when the dimensions of the finish shape have predetermined values or less, it is determined in step S5 that the hotspot A exists.

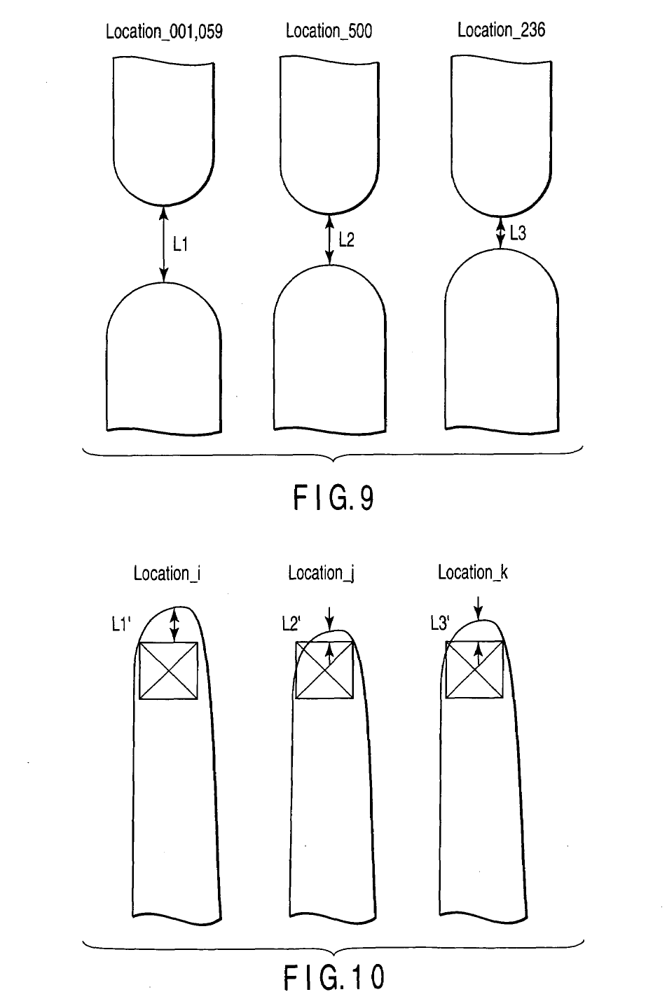

FIG. 9 shows examples of the finish shapes and dimensions of the hotspots A corresponding to standard cells_001 laid out at locations_001, 059, 236, and 500 shown in FIG. 4. In this case, the dimensions of the finish shapes are the distances (L1, L2, and L3) each indicating the distance between two adjacent patterns. The two adjacent patterns are formed in the same layer. Note that L1>L2>L3, and the distances L1, L2, and L3 have values of, e.g., 100, 90, and 80 nm. Location_236 having the shortest distance L3 is specified as the location including the most dangerous hotspot.

FIG. 10 is a view showing examples of the finish shapes and dimensions of hotspots A of another type.

Referring to FIG. 10, locations_i, j, and k are different from the other. In the examples shown in FIG. 10, the dimensions of the finish shapes are the distances (L1′, L2′, and L3′) each indicating the distance between an end of a pattern (interconnection metal here) and a contact hole CH. Note that L1′>L3′>L2′. In this case, location_j having the shortest distance L2′ is specified as the location including the most dangerous hotspot.

The methods of the above-described embodiments can also be practiced as programs. For example, a program related to the hotspot totalization method of the embodiment causes a computer to execute steps S1 to S8 in FIG. 1, 6, or 8.

A program related to the pattern correction method (without verification) of the embodiment causes a computer to execute step S9 (S9′) in FIG. 1, 6, or 8. A program related to the pattern correction method (with verification) of the embodiment causes a computer to execute steps S9 (S9′), S1, S3 to S5, and S7 (S7′) in FIG. 1, 6, or 8.

A program related to the cell library generation method of the embodiment causes a computer to execute steps S1 to S9 in FIG. 1, 6, or 8.

The programs are executed using hardware resources such as the CPU and memory in the computer (in some cases, an external memory is also used). The CPU reads out necessary data from the memory and executes the above steps (procedures) for the data. The result of each step (procedure) is temporarily saved in the memory, as needed, and read out when it is necessary in another step (procedure).

According to the embodiments of the present invention, it is possible to provide a hotspot totalization method of more easily determining whether a plurality of kinds of basic cells include a basic cell with a hotspot, a pattern correction method of correcting the basic cell with the hotspot, and a program.

Note that the present invention is not exactly limited to the above embodiments, and constituent elements can be modified in the execution stage without departing from the spirit and scope of the invention. Various inventions can be formed by properly combining a plurality of constituent elements disclosed in the above embodiments. For example, several constituent elements may be omitted from all the constituent elements described in the embodiments. In addition, constituent elements throughout different embodiments may be properly combined.

Various changes and modifications can be made without departing from the spirit or scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A hotspot totalization method comprising:
generating data related to a mask pattern on the basis of data related to a test pattern formed by laying out a plurality of kinds of basic cells Ci (I=1, 2, . . . ) at a plurality of locations Sij (j=1, 2, . . . );
acquiring a predicted pattern to be formed on a substrate by using the mask pattern by performing process simulation for the data related to the mask pattern, the process simulation being performed to acquire a plurality of predicted patterns based on a plurality of process parameters;
determining whether a first hotspot exists in each of the plurality of predicted patterns;
specifying a second hotspot on the test pattern corresponding to the first hotspot if it is determined that the first hotspot exists on the predicted pattern; and
totalizing, for each of the plurality of kinds of basic cells Ci, the number of locations Sij including the second hotspots.

2. The method according to claim 1, wherein in generating the data related to the mask pattern, optical proximity correction is executed for the data related to the test pattern.

3. The method according to claim 1, wherein the first hotspot indicates a spot which has, on the predicted pattern, a small margin relative to variations in the process parameters in the process simulation.

4. The method according to claim 1, wherein the process simulation includes lithography simulation and working simulation, the lithography simulation being performed based on process parameters in a lithography process, and the working simulation being performed based on process parameters in a working process.

5. The method according to claim 4, wherein the process parameters in the lithography simulation include at least one of an exposure dose and a focus amount, and the process parameters in the working simulation include at least one of an energy of an etchant, working time, and a variation in in-plane dimensions.

6. The method according to claim 4, wherein the first hotspot indicates a spot which has, on the predicted pattern, a small margin relative to variations in the process parameters in the lithography simulation and the working simulation.

7. The method according to claim 1, wherein the second hotspot is specified by defining a location of the basic cell Ci to which the second hotspot belongs.

8. The method according to claim 1, wherein the second hotspot is specified by defining a position in the basic cell Ci to which the second hotspot belongs.

9. A pattern correction method comprising:
generating data related to a mask pattern on the basis of data related to a test pattern formed by laying out a plurality of kinds of basic cells Ci (I=1, 2, . . . ) at a plurality of locations Sij (j=1, 2, . . . );
acquiring a predicted pattern to be formed on a substrate by using the mask pattern by performing process simulation for the data related to the mask pattern, the process simulation being performed to acquire a plurality of predicted patterns based on a plurality of process parameters;
determining whether a first hotspot exists in each of the plurality of predicted patterns;
specifying a second hotspot on the test pattern corresponding to the first hotspot if it is determined that the first hotspot exists on the predicted pattern;
totalizing, for each of the plurality of kinds of basic cells Ci, the number of locations Sij including the second hotspots;
selecting, from the plurality of kinds of basic cells Ci, the basic cell Ci including the second hotspot in at least one location Sij; and
correcting the test pattern of the basic cell Ci including the second hotspot in at least one location Sij to remove the second hotspot.

10. The method according to claim 9, wherein in correcting the test pattern of the basic cell Ci including the second hotspot in at least one location Sij, for a basic cell Ci including second hotspots in at least two locations Sij, the test pattern of a basic cell Ci laid out at a location with the most dangerous second hotspot is preferentially corrected.

11. The method according to claim 10, further comprising:
generating data related to a mask pattern on the basis of the preferentially corrected basic cell Ci and data related to a test pattern within a predetermined distance from the basic cell;
acquiring a predicted pattern to be formed on a substrate by using the mask pattern by performing process simulation for the data related to the mask pattern, the process simulation being performed to acquire a plurality of predicted patterns based on a plurality of process parameters;
determining whether the first hotspot exists in each of the plurality of predicted patterns; and
correcting the test pattern of the preferentially corrected basic cell Ci again if it is determined that the first hotspot exists.

12. The method according to claim 9, wherein in generating the data related to the mask pattern, optical proximity correction is executed for the data related to the test pattern.

13. The method according to claim 9, wherein the first hotspot indicates a spot which has, on the predicted pattern, a small margin relative to variations in the process parameters in the process simulation.

14. The method according to claim 9, wherein the process simulation includes lithography simulation and working simulation, the lithography simulation being performed based on process parameters in a lithography process, and the working simulation being performed based on process parameters in a working process.

15. The method according to claim 14, wherein the process parameters in the lithography simulation include at least one of an exposure dose and a focus amount, and the process parameters in the working simulation include at least one of an energy of an etchant, working time, and a variation in in-plane dimensions.

16. The method according to claim 14, wherein the first hotspot indicates a spot which has, on the predicted pattern, a small margin relative to variations in the process parameters in the lithography simulation and the working simulation.

17. The method according to claim 9, wherein the second hotspot is specified by defining a location of the basic cell Ci to which the second hotspot belongs.

18. The method according to claim 9, wherein the second hotspot is specified by defining a position in the basic cell Ci to which the second hotspot belongs.

19. A program to be executed by a computer, comprising:
generating data related to a mask pattern on the basis of data related to a test pattern formed by laying out a plurality of kinds of basic cells Ci (I=1, 2, . . . ) at a plurality of locations Sij (j=1, 2, . . . );
acquiring a predicted pattern to be formed on a substrate by using the mask pattern by performing process simulation for the data related to the mask pattern, the process simulation being performed to acquire a plurality of predicted patterns based on a plurality of process parameters;
determining whether a first hotspot exists in each of the plurality of predicted patterns;
specifying a second hotspot on the test pattern corresponding to the first hotspot if it is determined that the first hotspot exists on the predicted pattern; and
totalizing, for each of the plurality of kinds of basic cells Ci, the number of locations Sij including the second hotspots.

20. The program according to claim 19, wherein the first hotspot indicates a spot which has, on the predicted pattern, a small margin relative to variations in the process parameters in the lithography simulation and the working simulation.
